(19) United States
(12) Patent Application Publication
(10) Pub. No.: US 2010/0094737 A1
(43) Pub. Date: Apr. 15, 2010

(54) UTILITY COMMUNICATIONS DESIGN CONCEPT

(76) Inventors: Bryan Lambird, Culver City, CA (US); Jeff Gooding, Upland, CA (US); Jeremy McDonald, Carlsbad, CA (US)

Correspondence Address: SHELDON MAK ROSE & ANDERSON PC, 100 Corson Street, Third Floor, PASADENA, CA, 91103-3842, US

(21) Appl. No.: 12/542,107

(22) Filed: Aug. 17, 2009

Related U.S. Application Data
(60) Provisional application No. 61/089,649, filed on Aug. 18, 2008.

(51) Int. Cl. G06Q 50/00; G06Q 30/00; G06Q 10/00

(52) U.S. Cl. 705/34

(57) ABSTRACT

A system for recharging the batteries in an electrically powered vehicle which is owned or operated by an authorized party and wherein the recharging of the batteries is carried carried out at a site away from the premises owned or controlled by the authorizing party includes (a) first communication means for communicating between the site and an electrical utility for requesting the recharging of the batteries at the site, (b) authorization confirmation means for confirming that the authorized party is in fact authorized to recharge the batteries at the site, (c) second communication means between the electrical utility and the site for confirming authorization of the authorized party and for enabling the recharging of the batteries at the site, and (d) accounting means for calculating the cost of recharging the batteries and properly assessing that cost to the authorized party.

### CROSS-REFERENCE TO RELATED APPLICATIONS

This Application claims priority to Provisional Application Ser. No. 61/089,649, filed Aug. 18, 2008, entitled “Utility Communications Design Concepts” and which is incorporated in its entirety herein.

### BACKGROUND

The invention is directed to the problem of how to facilitate and promote the use of plug-in electric vehicles (PEVs).

At present, the owner of a PEV can only be confident that he or she can recharge his or her PEV at his or her own residence or his or her own business location. This is because the recharging of a PEV requires a reasonably significant input of electrical energy. There is no presently practical system and infrastructure for allowing the owner of a PEV to recharge his or her vehicle at a third party location without having to negotiate each time with the owner of the third party location for the necessary input of electrical power.

### SUMMARY

In one aspect of the invention, the invention is a system for recharging the batteries in an electrically powered vehicle which is owned or operated by an authorized party, wherein the recharging of the batteries is carried out at a site away from premises owned or controlled by the authorizing party, the system comprising (a) first communication means for communicating between the site and an electrical utility for requesting the recharging of the batteries at the site, (b) authorization confirmation means for confirming that the authorized party is in fact authorized to recharge the batteries at the site, (c) second communication means between the electrical utility and the site for confirming authorization of the authorized party and for enabling the recharging of the batteries at the site, and (d) accounting means for calculating the cost of recharging the batteries and properly assessing that cost to the authorized party.

### DRAWINGS

These and other features, aspects and advantages of the present invention will become better understood with reference to the following description, appended claims and accompanying drawings where:

FIG. 1 is a diagrammatic view illustrating a system having features of the invention for recharging the batteries in an electrically powered vehicle;

FIG. 2 are four diagrammatic views of several different embodiments of a system having features of the invention for recharging the batteries in an electrically powered vehicle;

FIG. 3 is a diagrammatic view of another embodiment of a system having features of the invention for recharging the batteries in an electrically powered vehicle; and

FIG. 4 is yet another diagrammatic view of a system having features of the invention for recharging the batteries in an electrically powered vehicle.

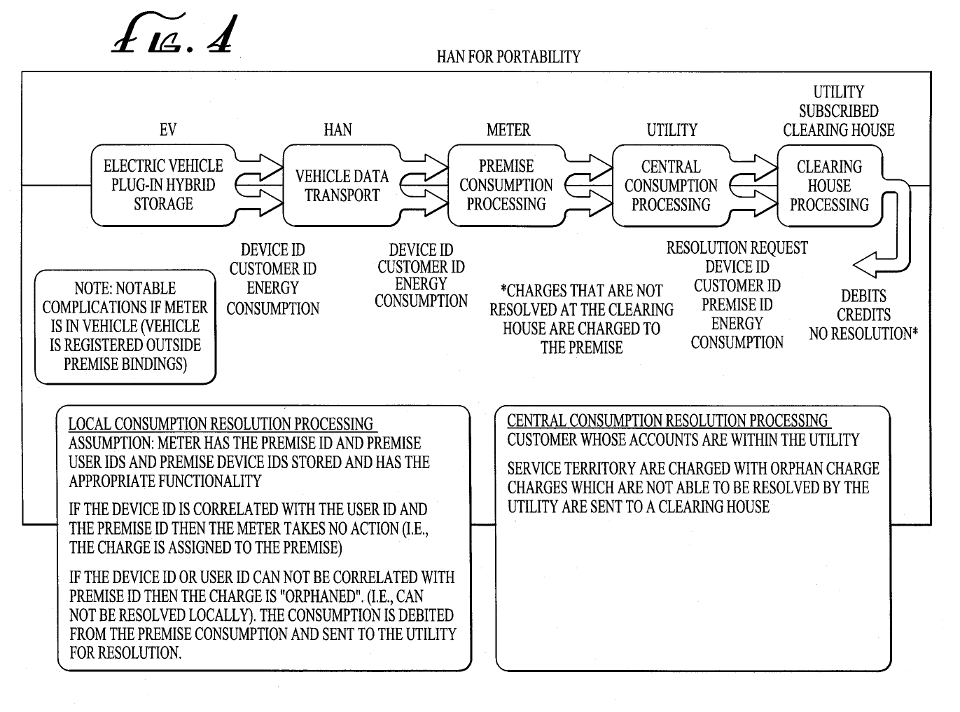

FIG. 5 is a diagrammatic view of the step-by-step actor-system interaction having features of the invention.

FIG. 6 is a diagrammatic view of the sequence of the step-by-step actor-system interaction.

FIG. 7 is a diagrammatic view of the step-by-step actor-system interaction having features of the invention.

FIG. 8 is a diagrammatic view of the sequence of the step-by-step actor-system interaction depicting scenarios 1, 2, and 3.

FIG. 9 is a diagrammatic view of the sequence of the step-by-step actor-system interaction depicting scenario 4.

### DETAILED DESCRIPTION

The invention provides systems and infrastructure for efficiently and conveniently allowing the owner of a PEV to recharge his or her PEV, both at facilities owned by the PEV owner and at third party sites.

The invention requires the following systems to be in place:

A Home Area Network (HAN) which will be the primary mechanism for exchange of information between PEV and utility. The HAN will be driven by a ZigBee wireless communications medium (802.15.4) or similar system provided by an electrical power use “smart meter” disposed at the PEV owner's facility, the smart meter being capable of interactive communication with an electric power utility via the HAN. The HAN supplied by the smart meter cannot directly send/receive communications via Powerline Carrier (PLC) or other medium.

Bridging technologies between 802.15.4 wireless and other communications media, notably PLC.

The invention requires that the PEV be registered with the utility.

In the invention, the PEV must first be registered with the utility. PEV Registration involves two important steps:

1. Initial ‘out of band’ registration of the PEV with the utility company, followed by

2. Initial binding between the communicating PEV and the communicating utility

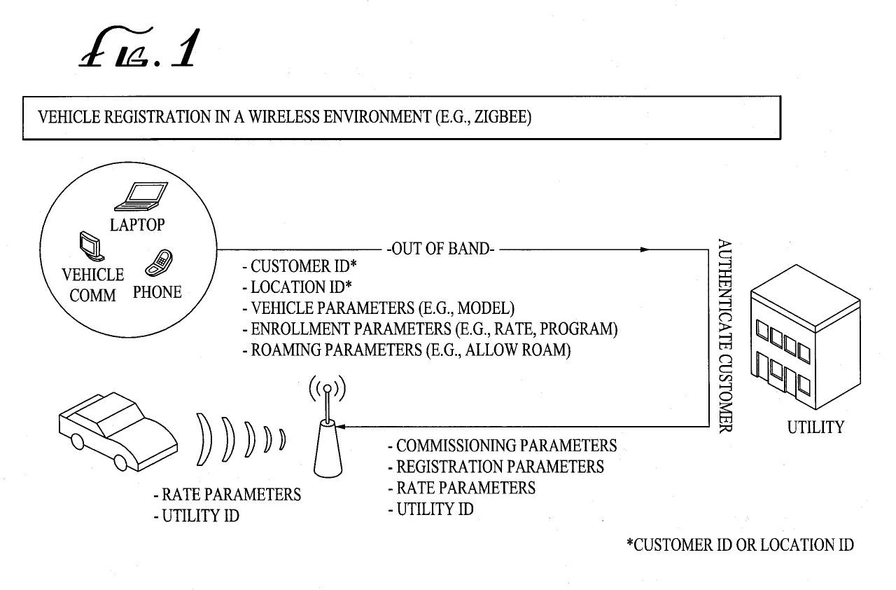

These steps are described in more detail below, and are diagramed in FIG. 1.

### Step 1: Out of Band Registration

Step one involves the upfront and one-time exchange of information between a PEV owner/operator and his/her electric utility such that the utility has a record of the PEV associated to the appropriate utility customer account at the primary premise(s) at which the PEV will engage in charging. This is likely to be accompanied with the enrollment in one or more utility programs providing services or incentives for customers with PEVs. Step one must be completed outside of the communications medium provided for ongoing PEV-utility communications so that the utility knows how to react to later requests for communication and handle the resulting messages exchanged between PEV and utility.

Out of band registration will require customer's identification and/or location information along with a unique PEV ID to be provided to the utility by the customer. Out of band communication to the utility could be accomplished by contacting the utility through returning paper documents, telephone/call center, or (preferably) via internet self-service, among other possible means. Optional data to be exchanged might include other vehicle parameters (e.g. make, model, battery size, etc.), enrollment parameters (e.g. programs, rates, charging preferences), and/or roaming parameters (e.g allow roaming, specific alternative roaming locations, etc.).

Step 2: Initial PEV [symbol] Utility Binding

Once out of band registration has established a record of the PEV vehicle-utility customer/location association within a utility information system, step two involves the initial communication and setup between the PEV and the utility through the utility provided HAN.

Multiple triggering events for establishing a communications ‘session’ between vehicle and PEV are possible, and will be discussed further in the Binding section (section 3) of this document. Information between utility and PEV will be transmitted as ZigBee Smart Energy (SE) Profile standard messages. Binding will occur via the premise (primary) Edison SmartConnect meter's HAN ZigBee 802.15.4 radio communicating to the PEV. The PEV might be able to communicate via its own ZigBee 802.15.4 radio, or via other ZigBee SE supported communications media such as PLC, Wi-Fi 802.11, or others, through the use of an 802.15.4 bridge. The preferred method for PEV communications medium will be discussed in the Binding section of this document (Section 3).

Once the initial communications session has been established, the utility will authenticate the PEV and provide it with commissioning and registration parameters which might include rate/program specific information (e.g. data recording intervals, on/off peak boundary times, specific kWH price information, etc.) depending on the parameters of programs/services that were enrolled into during step one above. A Utility ID (i.e. indicating the home utility) might also be provided to be stored within the PEV in support of foreign utility roaming, should such a roaming scenario be implemented (see section 4.2).

While enrollment & registration are not required for PEV charging, it will be required for PEV operators to benefit from services and/or incentives that the utility might offer to PEV users.

PEV binding is the process by which a PEV and the utility initiate a communications ‘session’ between each other. This is the regular & repeated communications activity which occurs each time that a PEV is attached to a utility energy portal for charging; it is distinct from the initial communications activity described in the PEV Registration Section.

Load correlation is the term to describe a situation where a communicating electric device (in this case a PEV) is attached to the same utility location/premise via both the energy portal/outlet and the HAN communications network. In the more specific case, load correlation means that the meter which is measuring load served to charge a PEV is the same meter providing/collecting HAN communications information to/from the PEV. The load correlation issue arises when load is served through one meter end point, while communications are served through a separate meter end point.

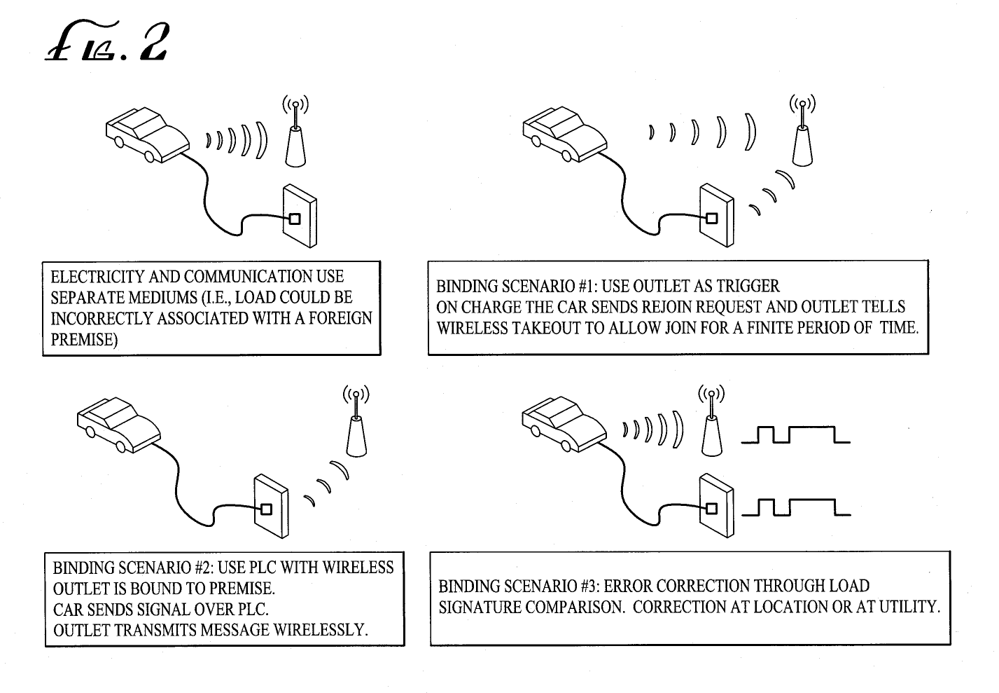

FIG. 2 below provides an initial image to illustrate the concepts of PEV binding and load correlation, followed by three potential scenarios which propose design solutions for PEV binding which limit or prevent load correlation problems. The first (upper left) image in FIG. 2 shows how it is possible that communications and electric load are served from distinct end points (e.g. meters). The following paragraphs will provide a description for scenarios 1-3, and will evaluate effectiveness of each scenario in preventing load correlation issues.

Scenario 1 indicates that PEV binding will be initiated by the act of plugging in the PEV to the energy portal (e.g. electrical outlet or other charging apparatus). Upon plugging in, PEV will issue ‘rejoin’ communications to the utility. This rejoin request may be specific to the charging location/premise, or may be generic (generic required for PEV roaming). At the same time, a ‘smart’ energy portal (or smart electrical outlet) detects power flow and issues an ‘allow rejoin’ communication to the designated utility takeout point (e.g. meter) for that energy portal. Once the meter receives an ‘allow rejoin’ request from the smart outlet it can also receive the ‘rejoin’ from the PEV, which would initiate the communications session.

A drawback to scenario 1 is that it requires special equipment at the charging location (smart energy portal/electrical outlet), and this equipment is not likely to be widely distributed to support roaming charging, at least during the adoption period for PEVs. This special equipment cannot be portable in support of roaming as this would create the same problem scenario 1 is attempting to resolve (i.e. smart energy portal/outlet could send ‘allow rejoin’ to an uncorrelated endpoint—especially in the multi-tenant situation). If the roaming scenario were not considered, scenario 1 would solve load correlation problems, except in the rare chance that multiple PEVs in the same vicinity are plugged in for charging at exactly the same time.

Scenario 2 begins similarly to Scenario 1 in that PEV binding is initiated by plugging in. However, instead of detecting power flow (as in scenario 1), a ‘smart’ energy portal/electrical outlet receives a PLC communication from the PEV identifying itself. Upon receipt of the PEV ID message via PLC, the smart energy portal/electrical outlet bridges the communication to wireless 802.15.4 and communicates this over the utility HAN to the meter endpoint and back to the utility. Because PLC is used from the PEV, the bridging technology can actually lie anywhere within the premise (e.g. ‘wall wart’ type device), and need not be specifically a smart energy portal/electrical outlet at the point of PEV charging.

Like scenario 1, a drawback to scenario 2 is that it also requires special equipment at the charging location (e.g. smart electrical outlet or ‘wall wart’ plug-in). However, because this equipment can be placed anywhere on the premise circuitry, initial installation in this scenario may be simpler. Overall communication and initiation of communications sessions between PEV and utility are also simplified in this scenario. Like scenario 1, special equipment is not portable to support roaming scenarios. This being said, limited portability could be supported if the bridging device could be associated to multiple specific premise locations most frequently used for roaming, and was modular (i.e. smart ‘wall wart’ example). Without roaming, scenario 2 would solve the load correlation issue, and also alleviates the issue raised in scenario 1 regarding simultaneous plugging in and binding of more than one PEV in a given vicinity.

Scenario 3 provides for a more advanced approach for PEV binding and load correlation. In this scenario electronic load signatures are tracked by the utility at metering end points and are also packaged up for collection via the wireless HAN. These signatures (one collected through the wire, the other via wireless HAN) could be compared to determine which PEV was charging at which premise at any given time. While this would theoretically eliminate load correlation problems, it would likely require significant back end computing power to collect, analyze, and compare load signatures for each PEV charging session. Also, more thought would have to be given as to how electronic signature traveling on PLC through a metering endpoint is ultimately collected and returned to the utility. It is likely that additional equipment to provide PLC to wireless bridging would also be required for this alternative.

It is assumed that the load correlation issue will be most important to solve for cases in which roaming programs are in place. However, even when charging at a single premise load correlation issues can still arise where communications binding occurs at the designated primary meter, but charging occurs through a non-correlated energy portal/electrical outlet. Such a situation is anticipated to be more prevalent at multi-tenant locations such as apartment buildings, condominiums, or retail centers.

PEV roaming is processes for PEV binding and charging away from the PEV's primary charging location, as designated in the PEV registration and enrollment process. PEV roaming can occur within the home utility service territory or beyond it, in a foreign or ‘roaming’ utility. These two separate scenarios are described in more detail below.

With PEV roaming, depending on the PEV user's registration/enrollment preferences with the utility, either the PEV user's or the premise/location customer's utility account may be billed for energy consumed for charging. When PEV-utility binding is not possible due to lack of or failure of HAN communications, energy consumption will be billed to the premise customer utility account by default.

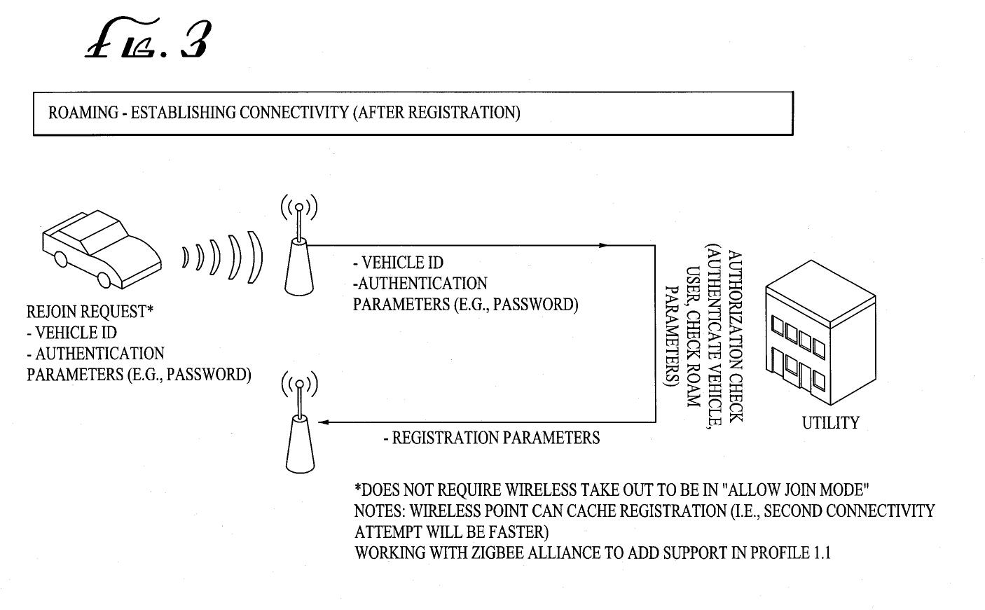

FIG. 3 below depicts the PEV roaming scenario when roaming is within the home utility service territory. The scenario begins with the PEV issuing a ‘rejoin’ request to the utility HAN communications takeout point (i.e. the smart meter). A communications ‘session’ with the PEV would be initiated once an ‘allow rejoin’ request is submitted by a ‘smart’ energy portal and received at the meter takeout point, enabling the takeout point to also receive the ‘rejoin’. Alternatively, a communications session could be initiated via PLC communication from the PEV bridged to the 802.15.4 Zigbee wireless communications medium for collection at the meter takeout point.

Again following the image in FIG. 3, once a communications session is established, the PEV's unique vehicle ID and any other authentication parameters (e.g. password) as required would be sent to the utility takeout point and back to the utility. The utility will perform an authorization check to confirm that this is a registered PEV (and therefore linked to a customer utility account) and will also retrieve any attributes related to the charging/roaming program that the PEV is registered/enrolled in. Any necessary registration parameters that might affect charging behavior are returned to the PEV. These parameters may or may not be able to be stored in the PEV. At this point PEV charging proceeds according to PEV operator preferences. Depending on the setup of the PEV program(s) in which the customer/PEV is enrolled, and depending on the specific premise location, energy costs for charging the PEV may accrue to the PEV operator or to the customer account associated to the charging premise/location.

If the attributes of the enrolled PEV program indicate that the charging costs are to be accrued to the PEV operator's account, this situation has been deemed an “orphaned” charge, requiring the utility to do the reconciliation of debiting the PEV operator's account while crediting the charging premise customer's account with the energy usage consumed for PEV charging.

It is envisioned that the information exchange described above, requiring an authentication step at the utility back office, may only be required for an initial communications session at any given roaming location. At the time of the initial session, relevant registration parameters can be stored/cached at the wireless takeout point, leading to improved performance in establishing communications for subsequent roaming to the same location. Endpoints will obviously have limitations as to the number of simultaneous PEVs that can be cached in local memory at any given time. Such limitations will be considered during the conceptual architecture and pre-engineering activities for these concepts.

PEV Roaming outside of the home electric utility service territory requires the existence of a cross-utility clearinghouse of which both the home utility and foreign/roaming utility are members. It also requires that the foreign/roaming utility has an available HAN communications medium which is compliant with the home utility's HAN application profile (i.e. the communications medium is compatible with the ZigBee SmartEnergy Profile messaging structures).

Proceed according to PEV customer preferences. Upon completion of PEV charging, the foreign/roaming utility will use clearinghouse services to settle the “orphaned” charge by debiting the PEV operator's home utility account with energy charges and crediting the corresponding usage amount to the customer account associated with the charging premise/location.

Any ability for foreign utility HAN takeout points to cache roaming PEV ID information to facilitate improved performance for subsequent roaming charging (at the same roaming location) is dependent on the capabilities of the foreign utility's HAN infrastructure. below provides an overall view of data communications flow between the PEV and the utility, inclusive of the concept of a clearinghouse to support foreign/roaming utility charges to be debited to the PEV operator's home utility account with corresponding usage credited to the premise/location customer in the foreign/roaming utility.

The foreign utility roaming scenario begins similarly to the home utility roaming scenario described in Section 4.1 above, with PEV ID information passing from the PEV to a foreign/roaming utility HAN takeout point and back to the roaming utility for an authorization check. In this case because the PEV is registered to its operator's home utility, while charging in a foreign utility territory, the PEV will fail the roaming utility's authorization check. PEV ID information will then be passed to the clearinghouse to determine if it is enrolled/registered with a participating utility PEV program. If a matching record is found within the clearinghouse, charging will proceed according to PEV customer preferences. Upon completion of PEV charging, the foreign/roaming utility will use clearinghouse services to settle the “orphaned” charge by debiting the PEV operator's home utility account with energy charges and crediting the corresponding usage amount to the customer account associated with the charging premise/location.

Any ability for foreign utility HAN takeout points to cache roaming PEV ID information to facilitate improved performance for subsequent roaming charging (at the same roaming location) is dependent on the capabilities of the foreign utility's HAN infrastructure.

In one embodiment of the invention, the customer enrolls in a PEV demand side management program. Such PEV demand side management program is described immediately below.

The Utility offers demand side management programs specifically for Customers with PEVs to enroll in. Participants in the selected PEV demand side management program may respond to requests by the Utility by reducing PEV load or shifting the time of day that the PEV is being charged. Scenarios for the following types of demand side management programs have been considered for this Use Case:
1) Customer is enrolled in a PEV Time-of-Use (TOU) pricing demand side management program (e.g., off-peak, mid-peak, on-peak, etc.).
2) Customer is enrolled in a PEV Discrete Event demand side management program (Direct Load Control).
3) Customer is enrolled in a PEV Periodic/Hourly Pricing Price Response program.

The selected demand side management program allows the customer to respond in different ways to the demand response request by Utility. Whenever a demand response request is initiated, the Utility notifies PEV Customers enrolled in applicable Utility PEV demand side management programs to encourage action. A variety of notification methods are selectable by the Customer (e.g., pager, e-mail, text message on cell phone, web page, etc).

### PEV Time-of-Use

For those customers enrolled in a PEV Time-of-Use (TOU) pricing demand side management program, applicable energy prices and rate periods (e.g., off-peak, mid-peak, on-peak, etc.) will be made known to the Customer and PEV. PEV initiates charging based on Customer-defined preference settings (considering peak/off-peak rate periods) in the PEV. PEV may not receive demand response discrete event notifications; however, some Customers enrolled in PEV TOU demand side management programs could also enroll in a Discrete Event demand side management program. Because no regular periodic communications between PEV and vehicle is required to support a basic PEV TOU pricing demand side management program, an explicit scenario for this option was not included in this use case. However, Utility-to-PEV communications for PEVs enrolled in a TOU demand side management program does offer other benefits (e.g., updated rates displayed in PEV).

### PEV Discrete Event

For those customers enrolled in a PEV Discrete Event demand side management program, Utility sends a discrete event request to PEV based upon a prediction of energy supply and/or grid reliability concerns. Such a message may direct the PEV to discontinue PEV charging until the demand response event is over, or until the time duration allowed for the event expires.

### PEV Periodic/Hourly Pricing

For those customers enrolled in a PEV Periodic/Hourly Pricing Price Response program, the utility will download day-ahead 24 hour prices for each hour to the PEV. PEV charging proceeds based on Customer-selected preference settings in the PEV.

Customer plugs PEV into Energy Portal to initiate charging. PEV senses power to on-board charging unit and activates ‘On Plug’ State. A communication session is established between the PEV and the Utility via an Energy Services Communication Interface (ESCI). ESCI handles communication session—including security—and transports all demand side management information between the PEV and Utility. PEV ID is transmitted to ESCI and on to Utility. Utility verifies PEV ID and Premise ID and sends back acknowledgement message. If PEV is enrolled in PEV demand side management program, Utility downloads discrete demand response event information or day-ahead periodic/hourly pricing table to PEV via ESCI.

PEV charging proceeds based on Customer settable preferences. The customer has the ability to override and opt out of demand response events for the PEV through Customer-configured preferences in the PEV. The customer may receive a reduced incentive for exercising this option. End Use Measurement Device records energy supplied to PEV for each charging session. End Use Measurement Device communicates energy supplied to PEV to ESCI, which in turn conveys this information to the Utility. Utility records each PEV charging session for bill generation and reporting.

The Utility will measure (using data from the End Use Measurement Device) the aggregate load reduction. This information can be fed back into a model used to determine the value of future load reduction requests.

This embodiment assumes the following:
High level assumption that PEV and utility have communications capabilities.
Demand Response events will be distributed to PEVs via utility-managed communications infrastructure, with ESCI available at end points; other non-Utility (e.g., cellular, Wi-Fi) communications mechanisms could be considered in additional scenarios.
The demand side management scenarios for this use case can only be applied to Customers that have enrolled in a Utility PEV demand side management program and have registered one or many PEVs with the Utility. The enrollment and registration scenarios are covered in a separate Use Case (P1).
End Use Measurement Device (EUMD) function can be located anywhere in a zone from the PEV and the branch circuit panel connection.
   The following chart details terms used in this embodiment:

| | Actor Type | |
|---|---|---|
| | (person, device, | |
| Actor Name | system etc.) | Actor Description |
| Customer | Person | Customer is the operator of a PEV and an electric customer of the home |
| | | utility. Customer enrolls in an electric utility PEV program and has selected a |
| | | PEV rate tariff. Customer is responsible for connecting PEV to an Energy |
| | | Portal for charging. Customer may have a unique Customer ID to allow for |
| | | customer portability across vehicles (e.g. rental car use case example) |
| PEV | System | Plug-in Electric Vehicle (PEV). Plugs into an Energy Portal (see actor |
| | | definition below) at a premise to charge vehicle. Capable of two-way |
| | | communications with the utility through the Energy Services Communication |
| | | Interface (ESCI). |
| Energy Portal | Device | Energy Portal is any charging point for PEV. At a minimum, the Energy |
| | | Portal is a 120 V, 15 A outlet but can also be a 240 V Electric Vehicle Supply |
| | | Equipment (EVSE) outlet connected to the premise circuit. |
| Utility | Organization | Utility typically refers to a collection of systems, business functions, and |
| | | organizations' which make up the electric utility that include the Customer |
| | | Information System (CIS), the Advanced Metering Infrastructure (AMI), Rates |
| | | and Revenue Services, etc. |
| Energy Services | System | Energy Services Communication Interface (ESCI) communicates with and |
| Communication Interface | | exchanges information between utility, PEV, and End Use Measurement |
| (ESCI) | | Device (EUMD). ESCI shall provide PEV charging session information to the |
| | | utility - PEV ID, interval kWhr consumption. Passes energy information, |
| | | including price signals and schedules, event messages, configuration and |
| | | security data from utility to PEV. This interface may or may not be facilitated |
| | | by an Advanced Metering Infrastructure (AMI) that includes a Home Area |
| | | Network (HAN). |
| End Use Measurement | Device | End Use Measurement Device (EUMD) measures and communicates energy |
| Device (EUMD) | | usage information payload to Energy Services Communication Interface |
| | | (ESCI). PEV EUMD shall provide PEV charging session info - PEV ID, |
| | | interval kWhr consumption. Receives configuration information (e.g. interval |
| | | for metering kWhr consumption) from utility. |
| Electric Vehicle Supply | Device | Electric Vehicle Supply Equipment (EVSE) is the physical electrical cord and |
| Equipment | | connectors that are specified by applicable SAE standards (e.g., SAE 2293, |
| | | SAE 1772, SAE J2836, etc.) that provide transfer of electrical energy from |
| | | energy portal to PEV. This can be 120 V or 240 V AC depending upon type |
| | | and size of energy portal. EVSE may or may not have communication |
| | | capability. EVSE may or may not have EUMD capability. |

The following is a step by step analysis of each scenario:
Customer is Enrolled in a PEV Discrete Event Demand Side Management Program (Direct Load Control) and PEV (and/or PEV Customer) Receives and Responds to Discrete Demand Response Events

For those customers enrolled in a PEV discrete event demand side management program (possibly in exchange for special PEV tariffs or other incentives), this program allows the utility to request an automated load reduction at the customer site by issuing event information to the PEV. The customer can override and/or opt-out of the request in exchange for a reduced incentive. Typically, PEV demand response events are downloaded at least 24 hours ahead, however they could be provided day-of in the case of a grid reliability emergency.

| | Primary Actor | | Post-Condition |
|---|---|---|---|
| Triggering Event | (Identify the actor whose | Pre-Condition | (Identify the post-conditions or significant |
| (Identify the name of the event | point-of-view is primarily | (Identify any pre-conditions or actor states | results required to consider the scenario |
| that start the scenario) | used to describe the steps) | necessary for the scenario to start) | complete) |
| As electrical system | PEV | Customer has subscribed to | Conditions that led to |
| approaches overload and/or | | a PEV demand side | constrained resources |
| resources become | | management discrete event | have abated or been |
| constrained | | program. | mitigated. Customer |
| | | | returns to normal PEV load |
| | | | operation. |

1.1.1 Steps for this Scenario

| Step # | Actor | Description of the Step | Additional Notes |
|---|---|---|---|
| 1 | Utility | Utility declares Demand Response event. | |
| 2 | Utility | At least 24 hours prior to event, Utility sends out | |
| | | remote notification to PEV Customers enrolled in | |
| | | PEV DR programs indicating demand response | |
| | | action. Notification can be via pager, e-mail, text | |
| | | message on cell phone, web page, etc. | |
| 3 | Customer | Customer selects/adjusts demand side | See Issue 1.0 (Section 6) |
| | | management preference(s) on PEV (if necessary) | |
| | | and connects PEV to energy portal at his local | |
| | | premise. | |
| 4 | PEV/Energy Services | PEV and Energy Services Communication | |
| | Communication | Interface (ESCI) perform PEV binding and | |
| | Interface (ESCI) | authentication process (See Use Case P1). | |
| 5 | Utility | Utility downloads demand response discrete | |
| | | event information to PEV via ESCI. Message | |
| | | includes event information or load reduction | |
| | | request notification. | |
| 6 | PEV | PEV charging proceeds based on Customer | |
| | | defined preferences (which considers receipt of | |
| | | demand side management information). | |
| 7 | Customer | Customer has the ability to override and/or opt- | Other means of indicating |
| | | out of demand response event using Customer- | override or opt-out (e.g., |
| | | configurable preferences in the PEV. Customer | outside of vehicle) may also |
| | | may receive a reduced incentive for exercising | be considered here. |
| | | this option. | |
| 8 | PEV | Upon selecting to override and/or opt-out of | See Issue 2.0 (Section 6) |
| | | demand response event, PEV will transmit | |
| | | message to Utility (via ESCI) to notify of | |
| | | Customer action. | |
| 9 | End Use Measurement | EUMD records energy supplied to PEV for each | |
| | Device | charging session. | |
| 10 | End Use Measurement | EUMD securely communicates energy supplied to | |
| | Device | PEV to ESCI for each charging session. | |
| 11 | ESCI | ESCI securely communicates energy supplied to | |
| | | PEV to Utility for each charging session. | |
| 12 | Utility | Utility records each PEV charging session for bill | |
| | | generation and reporting. Utility assesses | |
| | | customer actions (e.g., opt-out or override) during | |
| | | demand response event and may apply reduced | |
| | | incentive if necessary. | |

The following is a step by step analysis of each scenario.

### 1.2 Customer is Enrolled in a Periodic/Hourly Pricing Price Response Program and PEV Receives and Responds to Periodic/Hourly Energy Prices (Day-Ahead Schedule)

For those customers enrolled in a hourly price demand side management program, this program will download a schedule of 24 hours critical peak pricing for the next day, at least 24 hours ahead, based upon a prediction of energy shortages.

| | Primary Actor | | Post-Condition |
|---|---|---|---|
| Triggering Event | (Identify the actor whose | Pre-Condition | (Identify the post-conditions or significant |
| (Identify the name of the event | point-of-view is primarily | (Identify any pre-conditions or actor states | results required to consider the scenario |
| that start the scenario) | used to describe the steps) | necessary for the scenario to start) | complete) |
| Utility determines day-ahead | PEV | Customer has subscribed to | Conditions that led to |
| periodic/hourly pricing | | a PEV periodic/hourly pricing | constrained resources |
| | | demand side management | have abated or been |
| | | program. | mitigated. Customer return |
| | | | to normal PEV load |
| | | | operation. |

1.2.1 Steps for this Scenario

| | | | Additional Notes |
|---|---|---|---|
| | | | Elaborate on any additional description |
| | Actor | | or value of the step to help support the |
| | What actor, either primary or | Description of the Step | descriptions. Short notes on architecture |
| Step # | secondary is responsible for the | Describe the actions that take place in this step. | challenges, etc. may also be noted in this |
| # | activity in this step? | The step should be described in active, present tense. | column.. |
| 1 | Utility | Utility determines periodic/hourly prices for the next | |
| | | day, based on forecasts. | |
| 2 | Utility | In the case of abnormally high hourly prices, Utility may | |
| | | send out remote notification to PEV Customers enrolled | |
| | | in this type of PEV DR Program advising demand | |
| | | response action. Notification can be via pager, e-mail, | |
| | | text message on cell phone, web page, etc. | |
| 3 | Customer | Customer selects/adjusts demand side management | See Issue 1.0 (Section 6) |
| | | preference(s) on PEV (if necessary) and connects PEV | |
| | | to energy portal at his local premise. | |
| 4 | PEV/Energy Services | PEV and Energy Services Communication Interface | |
| | Communication Interface | (ESCI) perform PEV binding and authentication | |
| | (ESCI) | process (See Use Case P1). | |
| 5 | Utility | Utility downloads day-ahead periodic/hourly pricing rate | |
| | | table to PEV via ESCI. Table includes periodic/hourly | |
| | | prices for each period in the next day, or current | |
| | | day if table not yet downloaded for current day. | |
| 6 | PEV | PEV charging proceeds based on Customer-defined | |
| | | preferences (which considers current hourly/periodic | |
| | | pricing table). Customer may set or adjust limits for | |
| | | acceptable price for charging. | |
| 7 | End Use Measurement | EUMD records energy supplied to PEV for each | |
| | Device | charging session. | |
| 8 | End Use Measurement | EUMD securely communicates energy supplied to | |
| | Device | PEV to ESCI for each charging session. | |
| 9 | Energy Services | ESCI securely communicates energy supplied to | |
| | Communication Interface | PEV to Utility for each charging session. | |
| 10 | Utility | Utility records each PEV charging session for bill | Assumes that billing process will |
| | | generation and reporting. | correctly apply hourly prices to the |
| | | | appropriate usage intervals. |

The following list system preferences and requirements:

| | | Associated | Associated |
|---|---|---|---|
| Req | | Scenario # | Step # |
| ID | Functional Requirements | (if applicable) | (if applicable) |
| 1 | Utility shall track Customer preference for remote notification of PEV | 1, 2 | 2 |
| | Demand Response (DR) events. | | |
| 2 | Utility shall transmit PEV Demand Response event alerts to Customer via | 1, 2 | 2 |
| | Customer-designated communication channel(s). | | |
| 3 | The Energy Services Communication Interface (ESCI) shall exist at the | 1, 2 | 4 |
| | customer premise and be capable of securely communicating between the | | |
| | Utility and PEV to facilitate exchange of demand side management | | |
| | information. | | |
| 4 | PEV shall be capable of communicating to the Utility through an Energy | 1, 2 | 4 |
| | Services Communication Interface (ESCI). | | |
| 5 | PEV shall have a unique ID. | 1, 2 | 4 |
| 6 | PEV shall be capable of providing to the Energy Services Communication | 1, 2 | 4 |
| | Interface (ESCI) its unique PEV ID upon initiation of a communication | | |
| | session between PEV and ESCI. | | |
| 7 | Utility shall maintain information on all Customers and PEVs enrolled in the | 1, 2 | 4 |
| | PEV programs, including demand side management programs, associated | | |
| | PEV IDs, customer IDs, and premise IDs. | | |
| 8 | Utility shall be able to transmit discrete demand response event messages | 1 | 5 |
| | to an ESCI and onward to PEV. | | |
| 9 | Utility shall be able to transmit periodic/hourly pricing tables to an ESCI and | 2 | 5 |
| | onward to PEV. | | |
| 10 | PEV shall charge based on Customer-configurable preferences and shall | 1, 2 | 6 |
| | take appropriate action based upon discrete demand response events | | |
| | and/or a periodic/hourly price table. | | |
| 11 | Customer shall have the ability to override and/or opt-out of discrete | 1 | 7 |
| | demand response events. | | |
| 12 | PEV shall send Customer opt-out notification message to Utility | 1 | 8 |
| 13 | End Use Measurement Device shall discretely measure usage provided for | 1 | 9 |
| | PEV charging. | 2 | 7 |
| 14 | End Use Measurement Device (EUMD) function shall be inclusively located | 1 | 9 |
| | anywhere in a zone from the PEV and the branch circuit panel connection. | 2 | 7 |
| 15 | End Use Measurement Device shall be a meter capable of metering energy | 1 | 9 |
| | supplied to the PEV for each metering interval according to the tariff. | 2 | 7 |
| 16 | End Use Measurement Device shall record charging session information | 1 | 9 |
| | (e.g., PEV ID, Premise ID). | 2 | 7 |
| 17 | End Use Measurement Device shall allow for remote configuration of energy | 1 | 9 |
| | measurement interval length. | 2 | 7 |
| 18 | End Use Measurement Device shall report all PEV charging session | 1 | 10 |
| | information and energy usage for PEV charging to the Energy Services | 2 | 8 |
| | Communication Interface. | | |
| 19 | PEV, End Use Measurement Device, and Energy Services Communication | 1 | 4, 10 |
| | Interface shall employ appropriate security policies when communicating | 2 | 4, 8 |
| | demand side management program-related messages.. | | |
| 20 | Energy Services Communication Interface shall report all PEV charging | 1 | 11 |
| | session information and energy usage to Utility. | 2 | 9 |
| 21 | Utility shall apply correct rate structure for accurate customer billing | 1 | 12 |
| | considering any enrolled PEV demand side management programs and the | 2 | 10 |
| | benefits for compliance or charges for overrides and opt outs which are | | |
| | included in those programs. | | |

### Non-Functional Requirements

| | | Associated | Associated |
|---|---|---|---|
| Non-func. | | Scenario # | Step # |
| Req ID | Non-Functional Requirements | (if applicable) | (if applicable) |
| NF. 1 | Time will be maintained by each device in the system to UTC with 1 | 1 | 4, 5, 8, 9, 10, 11 |
| | second resolution | 2 | 4, 5, 7, 8, 9 |
| NF. 2 | EUMD shall record interval data configurable for interval lengths between 1 | 1 | 9 |
| | minute and 60 minutes inclusive. | 2 | 7 |
| NF. 3 | Pre-event notification shall be sent to customers in advance in a range | 1, 2 | 2 |
| | from one minute in an emergency up to 24 hours for normal/planned | | |
| | discrete demand response events. | | |

| | Step #, | Information | Information | |
|---|---|---|---|---|
| Scenario # | Step Name | Producer | Receiver | Name of information exchanged |
| 1, 2 | 4 | PEV | ESCI, Utility | PEV ID, Premise ID |
| 1 | 5 | Utility | ESCI, End Use | For each ‘On Plug’ state session and once-a-day |
| | | | Measurement | Verification of PEV ID |
| | | | Device, PEV | Verification of Premise ID |
| | | | | Demand Response discrete event information |
| 2 | 5 | Utility | ESCI, End Use | For each ‘On Plug’ state session and once-a-day |
| | | | Measurement | Verification of PEV ID |
| | | | Device, PEV | Verification of Premise ID |
| | | | | Day Ahead Periodic/Hourly 24 hour pricing rate table |
| 1 | 8 | Customer | PEV, ESCI, Utility | Indication of Customer Action to opt-out or override discrete |
| | | | | demand response event. |
| 1 | 10, 11 | End Use | ESCI, Utility | Charging session event message |
| 2 | 8, 9 | Measurement | | PEV ID |
| | | Device | | Premise ID |
| | | | | Metered energy supplied by each metering interval |

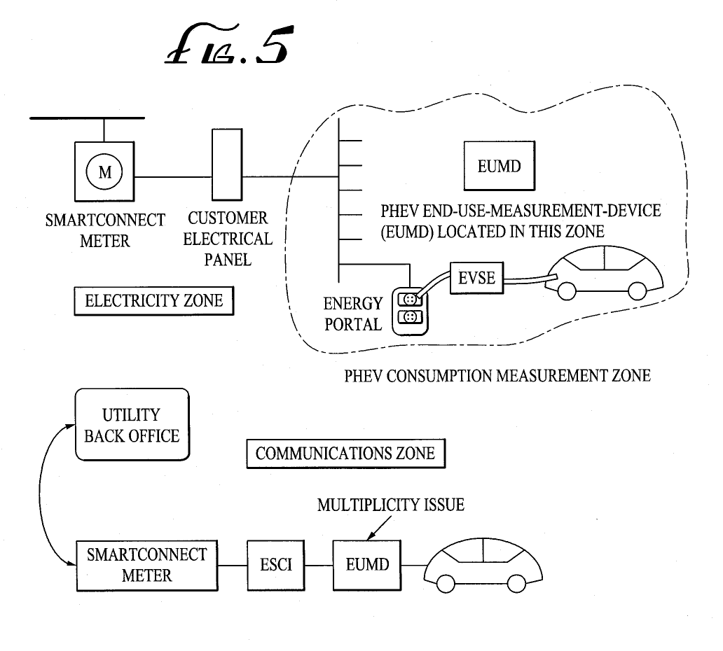

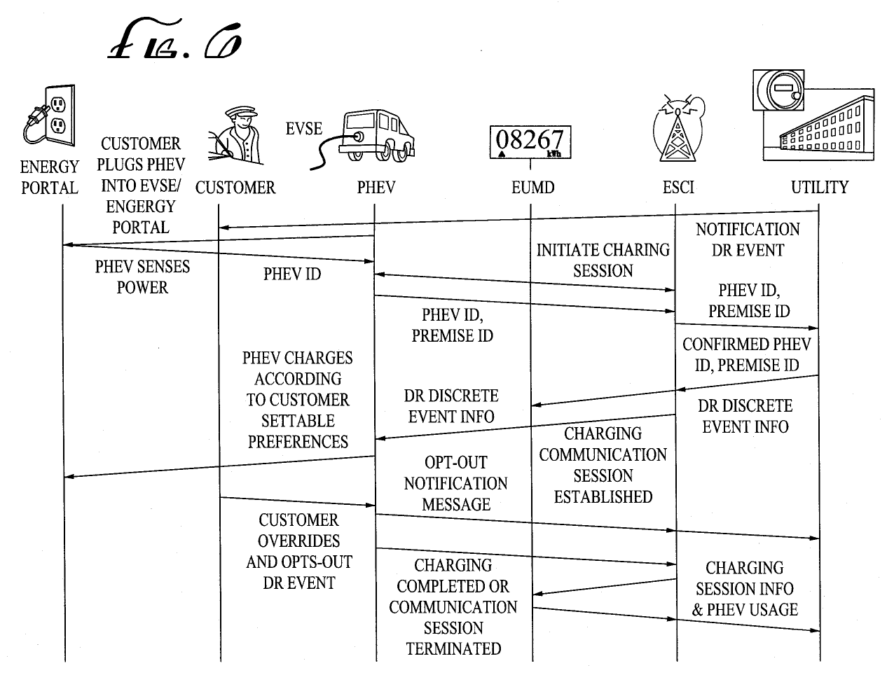

FIGS. 5 and 6 graphically describe the step-by-step actor-system interactions for the above scenarios.

In this embodiment, the following terms have the meaning as shown:

Glossary

| Term | Definition |
|---|---|
| Rate tariff | Energy cost schedule to customer. Can be time-of-day, flat |
| | rate, seasonal rate, critical peak price rate, etc. |
| PEV | Plug-in Electric Vehicle |
| EUMD | End Use Measurement Device, revenue measuring device |
| ESCI | Energy Services Communication Interface |
| Charging | Act of electrically charging a battery on-board a Plug-in |
| | Electric Vehicle or Electric Vehicle |

In another embodiment of the invention, the customer connects his or her PEV to a premise energy portal. This embodiment is described immediately below.

Customers are interested in fueling vehicles with electricity. Electric Vehicles (EV) and Plug-in Electric Vehicles (PEV) are emerging transportation options for customers. Electric utilities desire to support these emerging loads with electricity at “off peak” times when energy costs are low and generation and power delivery assets are underutilized. PEV manufacturers are interested in working with utilities to develop customer rates/programs which could provide customers with an increased incentive to purchase a PEV. Utilities may offer the Customer a PEV tariff that provides a low rate for off-peak charging and a higher rate for on-peak charging.

Upon plugging a PEV into an energy portal (120V or 240V), a communication session is initiated between the local Energy Services Communication Interface (ESCI) located at the premise and the PEV. The Utility validates that the Customer and the PEV ID are enrolled in a valid PEV program and that the there is correlation between the ESCI and the Energy Portal (that is, that the premise associated to the ESCI and the charging PEV are the same). Upon validation, PEV charging begins, and an End Use Measurement Device (EUMD) tracks electricity supplied during the charging session. If communications cannot be established, or if PEV fails validation, charging will continue; however, no special PEV incentive will be applied. Upon termination of charging session, the End Use Measurement Device logs the charging session information and reports data to the utility for billing and presentation to the Customer.

This use case covers five scenarios:
1) Customer connects PEV to energy portal at his premise location
2) Customer connects PEV to energy portal at another premise and premise customer pays for energy use
3) Customer connects PEV to energy portal at another premise and PEV customer pays for energy use
4) Customer connects PEV to energy portal at another premise outside the enrolled Utility's service territory
5) Non-enrolled PEV (or Customer with non-communicating PEV) connects PEV to energy portal
   This embodiment assumes the following:
High level assumption that PEV and utility have communications capabilities.

For a foreign utility scenario (Scenario 3.4), assumption is that roaming utility also has communications capabilities.
In the absence or failure of PEV-utility communications, or if PEV ID validation fails, PEV charging will always proceed; however, without the incentive rates and with all energy charges accruing to the premise customer according to the premise customer's default rate/service plan.
The PEV charging process for this use case can only be applied to customers that have already enrolled in a utility PEV program and have registered one or more PEVs in advance of charging. The enrollment and initial registration scenarios will be covered in a separate use case (Use Case P1). Steps for repeat binding of PEV to premise are also covered in Use Case P1.
End Use Measurement Device (EUMD) is always available for PEV charging. If not available, charging will proceed without incentive rates and with all energy charges accruing to the premise customer.
End Use Measurement Device (EUMD) function can be inclusively located anywhere in a zone from the PEV and the branch circuit panel connection.
Unenrolled PEV is prohibited from binding to Utility devices or network (Energy Services Communication Interface). However, PEV charging will be able to proceed with the assumptions already documented.
Foreign utility scenario (Scenario 3.4) assumes the existence of a cross-utility clearinghouse (available to all utilities) which can reconcile roaming utility PEV charging between premise customer of one utility and PEV operator/customer of a different utility. The concept of portability of multiple separate utility customers (with separate utility accounts) across a given PEV on a regular basis (e.g., rental car scenario) is not explicitly considered in this use case. This may be covered in a future use case.
   The following chart illustrates the “actors” involved in this embodiment.

| | Actor Type | |
|---|---|---|
| | (person, device, | |
| Actor Name | system, etc.) | Actor Description |
| Customer | Person | Customer is the operator of a PEV and an electric customer of the home |
| | | utility. Customer enrolls in an electric utility PEV program and has selected |
| | | a PEV rate tariff. Customer is responsible for connecting PEV to an Energy |
| | | Portal for charging. Customer may have a unique Customer ID to allow for |
| | | customer portability across vehicles (e.g., rental car use case example) |
| PEV | System | Plug-in Electric Vehicle (PEV). Plugs into an Energy Portal (see actor |
| | | definition below) at a premise to charge vehicle. Capable of two-way |
| | | communications with the utility through the Energy Services |
| | | Communications Interface (ESCI). |
| Energy Portal | Device | Energy Portal is any charging point for a PEV. At a minimum, the Energy |
| | | Portal is a 120 V, 15 A outlet but can also be a 240 V Electric Vehicle Supply |
| | | Equipment (EVSE) outlet connected to the premise circuit. |
| Utility | Organization | Utility typically refers to a collection of systems, business functions, and |
| | | organizations' which make up the electric utility that include the Customer |
| | | Information System (CIS), the Advanced Metering Infrastructure (AMI), |
| | | Rates and Revenue Services, etc. |
| Energy Services | System | Energy Services Communication Interface (ESCI) communicates with and |
| Communication | | exchanges information between utility, PEV, and End Use Measurement |
| Interface (ESCI) | | Device (EUMD). ESCI shall provide PEV charging session information to |
| | | the utility - PEV ID, interval kWhr consumption. Passes energy information, |
| | | including price signals, schedules, event messages, configuration, and |
| | | security data from the utility to the PEV. This interface may or may not be |
| | | facilitated by an Advanced Metering Infrastructure (AMI) that includes a |
| | | Home Area Network (HAN). |
| End Use Measurement | Device | End Use Measurement Device (EUMD) measures and communicates energy |
| Device (EUMD) | | usage information payload to Energy Services Communication Interface |
| | | (ESCI). PEV EUMD shall provide PEV charging session info - PEV ID, |
| | | interval kWhr consumption. Receives configuration information (e.g., |
| | | interval for metering kWhr consumption) from utility. |
| Electric Vehicle Supply | Device | Electric Vehicle Supply Equipment (EVSE) is the physical electrical cord and |
| Equipment | | connectors that are specified by applicable SAE standards (e.g., SAE 2293, |
| | | SAE 1772, SAE J2836, etc.) that provide transfer of electrical energy from |
| | | energy portal to PEV. This can be 120 V or 240 V AC depending upon type |
| | | and size of energy portal. EVSE may or may not have communication |
| | | capability. EVSE may or may not have EUMD and/or ESCI communications |
| | | capability. |
| Roaming Utility | Organization | Electric Service Provider that is supplying energy to PEV when PEV is |
| | | outside of the Customer's Utility service territory |
| Clearinghouse | Organization | Organization that provides global PEV account services. Maintains |
| | | information necessary to facilitate account validation and billing transaction |
| | | when Customer is charging PEV at a location not served by the Utility that |
| | | the Customer is enrolled with. |

Several different scenarios of this embodiment are detailed below:

This scenario describes the most common sequence of customer charging their PEV at their own premise. As described in the main Narrative section, the customer is attempting to charge a PEV under a selected PEV rate tariff that may provide an incentive to charge during off peak periods. The utility needs to support customers on the PEV program.

| Triggering Event | Primary Actor | Pre-Condition | Post-Condition |
|---|---|---|---|
| The customer plugs in the | PEV | Customer has enrolled PEV | The utility has a record of |
| PEV into energy portal | | with home utility. | the energy purchased |
| | | | transactions related to the |
| | | | customer premise and the |
| | | | associated PEV ID. |

1.2.2 Steps for this Scenario

| Step # | Actor | Description of the Step | Additional Notes |
|---|---|---|---|
| 1 | Customer | Customer connects PEV to energy portal at his | |
| | | premise location. | |
| 2 | PEV/Energy Services | PEV and Energy Services Communications | |
| | Communications | Interface (ESCI) perform PEV binding and | |
| | Interface (ESCI) | authentication process. (See Use Case P1) | |
| 3 | PEV | PEV is able to provide indicator to customer that | |
| | | binding has been successful (and that the PEV | |
| | | will receive incentive rate upon charging, if | |
| | | applicable). | |
| 4 | PEV | PEV begins charging based on Customer- | |
| | | selected preferences. Charging may be delayed | |
| | | based upon Customer preferences or grid | |
| | | reliability criteria (e.g., off-peak economy | |
| | | charging, demand response event underway, | |
| | | short, randomized charging delay to promote grid | |
| | | stability, etc.) | |
| 5 | End Use Measurement | EUMD records charging information and energy | |
| | Device | supplied to PEV for each charging session. | |
| | | Charging information includes PEV ID, Premise | |
| | | ID, energy usage, and time stamp for each | |
| | | metering interval. | |
| 6 | End Use Measurement | EUMD communicates to Energy Services | This communication could be |
| | Device | Communication Interface the energy supplied to | on a periodic basis during |
| | | PEV for each charging session. | charging, upon vehicle unplug |
| | | | from energy portal, or a |
| | | | combination of the two. |
| | | | See Issue 5.0 (Section 6) |
| 7 | Energy Services | Energy Services Communication Interface | |
| | Communication | communicates to Utility the energy supplied to | |
| | Interface | PEV for each charging session. | |
| 8 | Utility | Utility records each PEV charging session for bill | |
| | | generation and reporting to customer account | |
| | | associated with this premise and PEV ID. | |

### 1.3 Primary Scenario: Customer Connects PEV to Energy Portal at Another Premise and Premise Customer Pays for Energy Use

This scenario describes what happens if a Customer plugs PEV into another premise (not his own, but one serviced by the same utility), where the premise owner is responsible for the cost of energy delivered to the PEV charged at the premise.

| Triggering Event | Primary Actor | Pre-Condition | Post-Condition |
|---|---|---|---|
| The customer plugs in the | PEV | Customer has enrolled PEV | The utility has a record of |
| PEV into energy portal | | with home utility. | the energy purchased |
| | | | transactions related to |
| | | | the customer premise and |
| | | | the associated PEV ID. |

1.3.1 Steps for this Scenario

| Step # | Actor | Description of the Step | Additional Notes |
|---|---|---|---|
| 1 | PEV | PEV connects to energy portal at another customer | PEV may display message |
| | | location within the Utility service territory, and the | communicating charging/billing |
| | | customer at this location is willing to pay for PEV | options or information to the |
| | | charging energy. | Customer. |
| 2 | PEV/Energy Services | PEV and Energy Services Communications Interface | |
| | Communications | (ESCI) perform PEV binding and authentication | |
| | Interface (ESCI) | process (see Use Case P1). | |
| 3 | PEV | PEV is able to provide indicator to customer that | |
| | | binding has been successful (and that he will receive | |
| | | incentive rate upon charging, if applicable). | |
| 4 | PEV | PEV begins charging based on Customer-selected | |
| | | preferences. Charging may be delayed based upon | |
| | | Customer preferences or grid reliability criteria (e.g., off- | |
| | | peak economy charging, demand response event | |
| | | underway, short, randomized charging delay to | |
| | | promote grid stability, etc.) | |
| 5 | End Use Measurement | EUMD records charging information and energy | |
| | Device | supplied to PEV for each charging session. Charging | |
| | | information includes PEV ID, Premise ID, energy | |
| | | usage, and time stamp for each metering interval. | |
| 6 | End Use Measurement | EUMD communicates to Energy Services | This communication could be on a |
| | Device | Communication Interface energy supplied to PEV for | periodic basis during charging, |
| | | each charging session. | upon vehicle unplug from energy |
| | | | portal, or a combination of the |
| | | | two. |
| | | | See Issue 5.0 (Section 6) |
| 7 | Energy Services | Energy Services Communication Interface (ESCI) | |
| | Communication Interface | communicates to Utility energy supplied to PEV ID for | |
| | | each charging session. | |
| 8 | Utility | Utility records each PEV charging session for bill | |
| | | generation and reporting to the customer account | |
| | | associated with the premise at which the PEV was | |
| | | charged. The Customer account associated with the | |
| | | PEV ID is not charged. | |

### 1.4 Primary Scenario: Customer Connects PEV to Energy Portal at Another Premise and PEV Customer Pays for Energy Use

This scenario describes what happens if customer plugs PEV into another premise (not his own, but serviced by the same utility), where the PEV operator is responsible for the cost of energy delivered to the PEV charged at the premise.

| Triggering Event | Primary Actor | Pre-Condition | Post-Condition |
|---|---|---|---|
| The customer plugs in the | PEV | Customer has enrolled PEV | The utility has a record of |
| PEV into energy portal | | with home utility. | the energy purchased |
| | | | transactions related to the |
| | | | customer premise and the |
| | | | associated PEV ID. |

1.4.1 Steps for this Scenario

| Step # | Actor | Description of the Step | Additional Notes |
|---|---|---|---|
| 1 | PEV | PEV connects to energy portal at another customer | PEV may display message |
| | | location within the Utility service territory. PEV owner | communicating charging/billing |
| | | will pay for charging. | options or information to the |
| | | | Customer. |
| 2 | PEV/Energy Services | PEV and Energy Services Communications Interface | |
| | Communications | (ESCI) perform PEV binding and authentication | |
| | Interface (ESCI) | process (see Use Case P1). | |
| 3 | PEV | PEV is able to provide indicator to customer that | |
| | | binding has been successful (and that he will receive | |
| | | incentive rate upon charging, if applicable). | |
| 4 | PEV | PEV begins charging based on Customer selected | |
| | | preferences. Charging may be delayed based upon | |
| | | Customer preferences or grid reliability criteria (e.g., off- | |
| | | peak economy charging, demand response event | |
| | | underway, short, randomized charging delay to | |
| | | promote grid stability, etc.) | |
| 5 | End Use Measurement | EUMD records charging information and energy | |
| | Device | supplied to PEV for each charging session. Charging | |
| | | information includes PEV ID, Premise ID, energy | |
| | | usage, and time stamp for each metering interval. | |
| 6 | End Use Measurement | EUMD communicates to Energy Services | This communication could be on a |
| | Device | Communication Interface energy supplied to PEV ID for | periodic basis during charging, |
| | | each charging session. | upon vehicle unplug from energy |
| | | | portal, or a combination of the |
| | | | two. |
| | | | See Issue 5.0 (Section 6) |
| 7 | Energy Services | Energy Services Communications Interface (ESCI) | |
| | Communication Interface | communicates to Utility energy supplied to PEV for | |
| | | each charging session. | |
| 8 | Utility | Utility records each PEV charging session for bill | See Issue 8.0 (Section 6) |
| | | generation and reporting to the customer account | |
| | | associated with this PEV ID. Customer account | |
| | | associated with this premise will be credited for energy | |
| | | supplied for this charging session. | |

### 1.5 Primary Scenario: Customer Connects PEV to Energy Portal at Another Premise Outside the Enrolled Utility's Service Territory

This scenario describes what happens if customer plugs PEV into another premise (not his own, and not serviced by the same utility (i.e. roaming utility), where the PEV operator is responsible for the cost of energy delivered to the PEV charged at the premise.

| Triggering Event | Primary Actor | Pre-Condition | Post-Condition |
|---|---|---|---|
| The customer plugs in the | PEV | Customer has enrolled PEV | The foreign/roaming utility |
| PEV into energy portal | | with home utility. | and the clearinghouse has |
| | | Both home and | a record of the energy |
| | | foreign/roaming utility | purchased transactions |
| | | participate in inter-utility | related to the customer |
| | | clearinghouse. | premise, the PEV ID, the |
| | | | Customer ID, and the |
| | | | Utility ID. |

1.5.1 Steps for this Scenario

| Step # | Actor | Description of the Step | Additional Notes |
|---|---|---|---|
| 1 | PEV | PEV connects to energy portal at a location outside of | PEV may display message |
| | | the home Utility service territory. PEV owner will pay | communicating charging/billing |
| | | for charging. | options or information to the |
| | | | Customer. |
| 2 | PEV | PEV senses power to on-board charging unit and | |
| | | activates ‘On Plug’ state. | |
| 3 | PEV/Energy Services | PEV and Energy Services Communications Interface | Implementation could have PEV |
| | Communications | (ESCI) initiate a secure communications session. | or ESCI as initiator of session. |
| | Interface (ESCI) | | |
| 4 | PEV | PEV ID is transmitted to ESCI. | Unique PEV ID will ultimately |
| | | | support portability of charging, |
| | | | among other purposes. |
| 5 | ESCI | ESCI maintains communication session and security | |
| | | between PEV and Roaming Utility. ESCI transmits | |
| | | request for validating PEV ID to Roaming Utility, | |
| | | including Premise ID. | |
| 6 | Roaming Utility | Roaming Utility checks PEV ID and Premise ID against | |
| | | internal database. When not found (because PEV is | |
| | | registered with home utility), Roaming utility forwards | |
| | | PEV ID and Roaming Utility ID to Clearinghouse for | |
| | | verification. | |
| 7 | Clearinghouse | Clearinghouse checks PEV database for PEV ID and | Underlying assumption is that |
| | | finds corresponding Home Utility ID, and Home Utility | PEV has been registered with |
| | | Account/Premise ID. | home utility and that both utilities |
| | | | participate in the clearinghouse. |
| 8 | Clearinghouse | Clearinghouse transmits confirmed message to | See Issue 10.0 (Section 6) |
| | | Roaming Utility, including PEV ID, Home Utility ID, and | |
| | | Home Utility Account/Premise ID. | |
| 9 | Roaming Utility | Roaming Utility transmits confirmed message via ESCI | |
| | | to End Use Measurement Device (EUMD) indicating | |
| | | successful binding with premise ESCI. | |
| 10 | ESCI | ESCI transmits confirmation message to PEV indicating | |
| | | successful communication session binding of PEV to | |
| | | Roaming Utility at PEV program tariff. PEV is able to | |
| | | provide indicator to customer that binding has been | |
| | | successful (and that he will receive incentive rate upon | |
| | | charging, if applicable). PEV begins charging based on | |
| | | Customer selected preferences. Charging may be | |
| | | delayed based upon Customer preferences or grid | |
| | | reliability criteria (e.g., off-peak economy charging, | |
| | | demand response event underway, short, randomized | |
| | | charging delay to promote grid stability, etc.) | |
| 11 | End Use Measurement | EUMD records charging information and energy | |
| | Device | supplied to PEV for each charging session. Charging | |
| | | information includes PEV ID, Premise ID, energy | |
| | | usage, and time stamp for each metering interval. | |
| 12 | End Use Measurement | EUMD communicates to Energy Services | This communication could be on a |
| | Device | Communication Interface energy supplied to PEV ID for | periodic basis during charging, |
| | | each charging session. | upon vehicle unplug from energy |
| | | | portal, or a combination of the |
| | | | two. |
| | | | See Issue 5.0 (Section 6) |
| 13 | Energy Services | Energy Services Communications Interface (ESCI) | |
| | Communication Interface | communicates to Roaming Utility energy supplied to | |
| | | PEV for each charging session. | |
| 14 | Roaming Utility | Roaming Utility records each PEV charging session for | |
| | | reporting to Clearinghouse. Customer account | |
| | | associated with this roaming utility premise will be | |
| | | credited for energy supplied for this charging session. | |
| 15 | Roaming Utility | Roaming Utility forwards transaction to Clearinghouse | |
| | | for energy supplied to PEV including PEV ID, Customer | |
| | | ID, Home Utility ID, and interval based charging | |
| | | session information. | |
| 16 | Clearinghouse | Clearinghouse receives energy charge transaction from | See Issue 8.0 (Section 6) |
| | | Roaming Utility for posting charges to PEV operator's | See Issue 9.0 (Section 6) |
| | | home utility Customer account. | |

1.6 Primary Scenario: Non-Enrolled PEV (or Customer with Non-Communicating PEV) Connects to Energy Portal

This scenario describes what happens if an unenrolled PEV can communicate with local area network (e.g., LAN, HAN, PAN) or Customer has PEV that cannot communicate or cannot communicate with a specific Utility's network.

| Triggering Event | Primary Actor | Pre-Condition | Post-Condition |
|---|---|---|---|
| The customer plugs in the | PEV | Customer has a PEV, but is | No communication session |
| PEV into energy portal | | unenrolled in a Utility PEV | established with Utility |
| | | program, has a non- | network or devices. PEV |
| | | communicating PEV, or both. | charges successfully with |
| | | | all energy charges |
| | | | accruing to charging |
| | | | premise account. |

1.6.1 Steps for this Scenario

| Step # | Actor | Description of the Step | Additional Notes |
|---|---|---|---|
| 1 | PEV | PEV connects to energy portal at any customer | |
| | | location. This could be in the PEV operator's home | |
| | | utility service territory or in a foreign utility service | |
| | | territory. | |
| 2 | PEV | PEV senses power to on-board charging unit and | |
| | | activates ‘On Plug’ state | |
| 3 | PEV/Energy Services | PEV (if communications enabled) and Energy Services | Implementation could have PEV |
| | Communications | Communications Interface (ESCI) initiate a secure | or ESCI as initiator of session. |
| | Interface (ESCI) | communications session. | If PEV does not have |
| | | | communications capability (or if |
| | | | comms disabled), charging will |
| | | | commence with all energy |
| | | | charges accruing to premise |
| | | | customer at default rate for |
| | | | customer account. |
| 4 | PEV | PEV ID is transmitted to ESCI | |
| 5 | Utility | Utility checks PEV ID, Premise ID against internal | |
| | | database. If not found (because PEV is roaming | |
| | | outside of home utility), utility forwards PEV ID to | |
| | | Clearinghouse for verification. | |
| 6 | Utility/Clearinghouse | Neither utility nor clearinghouse has record of the | Utility will have PEV ID of |
| | | PEV ID | unenrolled PEV, should it desire |
| | | | to identify it and contact operator |
| | | | regarding potential enrollment in |
| | | | utility program. |
| 7 | PEV | PEV begins charging based on Customer selected | |
| | | preferences. All energy charges accrue to premise | |
| | | account. | |

### 2. Requirements

### 2.1 Functional Requirements

| | | Associated | Associated |
|---|---|---|---|
| Req | | Scenario # | Step # |
| ID | Functional Requirements | (if applicable) | (if applicable) |
| 1 | PEV shall be capable of plugging into EVSE enabled 120 V or 240 V AC energy | 1, 2, 3, 4, 5 | 1 |
| | portal to receive a charge of electric energy. | | |
| 2 | Premise supports charging multiple PEVs simultaneously, both “home” and | 1, 2, 3, 4, 5 | 1 |
| | guest”. | | |
| 3 | PEV shall be able to charge upon plugging into EVSE enabled 120 V or 240 V AC | 1, 2, 3 | 4 |
| | energy portal (with or without communications established with utility) | 4 | 10 |
| | | 5 | 7 |
| 4 | The PEV shall be capable of sensing ‘on plug’ state, participating in | 4, 5 | 2 |
| | communications with ESCI, and proceeding with charging according to customer | | |
| | selected preference. | | |
| 5 | The Energy Services Communication Interface shall exist at the customer | 1, 2, 3 | 2 |
| | premise and be capable of communicating to the Utility and can communicate to | 4, 5 | 3 |
| | the PEV to facilitate exchange of charging session information. | | |
| 6 | Vehicle is communicating to the utility through an Energy Services | 1, 2, 3 | 3, 4 |
| | Communication Interface (ESCI) | | |
| 7 | PEV has a unique ID, which can be stored within and communicated from PEV. | 1, 2, 3 | 5 |
| | | 4, 5 | 4 |
| 8 | The PEV shall be capable of providing to the Energy Services Communication | 4, 5 | 4 |
| | Interface (ESCI) its unique PEV ID upon initiation of a communications session | | |
| | between PEV and ESCI. | | |
| 9 | The Utility shall maintain information on all Customers and PEVs enrolled in the | 4 | 6 |
| | PEV programs, associated PEV IDs, Customer IDs, and premise IDs. | 5 | 5 |
| 10 | Utility shall be able to determine customers/premises not enrolled in PEV | 5 | 6 |
| | program. | | |
| 11 | Utility has established message and data interface exchange mechanism with | 4 | 6, 8 |
| | Clearinghouse for verification of roaming PEV. | 5 | 5 |
| 12 | Utility shall be able to verify that usage attributable to PEV charging is sourced | 1, 2, 3 | 2 |
| | from the same customer/premise that has provided the ESCI for PEV-to-Utility | 4 | 5 |
| | communications (e.g., Load correlation to ESCI communications). | 5 | 3 |
| 13 | PEV capable of receiving a confirmation message from Utility via ESCI | 1, 2, 3 | 3 |
| | establishing valid charging session. This indication can in turn be made | 4 | 10 |
| | available to customer to indicate that communications session has been | | |
| | successfully established. | | |
| 14 | An End Use Measurement Device is required to discretely measure usage | 1, 2, 3, | 5 |
| | provided for PEV charging. | 4 | 11 |
| 15 | End Use Measurement Device (EUMD) function can be inclusively located | 1, 2, 3 | 5 |
| | anywhere in a zone from the PEV and the branch circuit panel connection | 4 | 11 |
| 16 | The End Use Measurement Device shall be a meter capable of metering energy | 1, 2, 3 | 5 |
| | supplied to the PEV for each metering interval according to the tariff | 4 | 11 |
| 17 | The End Use Measurement Device shall be capable of recording charging | 1, 2, 3 | 5 |
| | session information (e.g., PEV ID, Premise ID). | 4 | 11 |
| 18 | PEV End Use Measurement Device is utility-, auto manufacturer-, and state | 1, 2, 3 | 5 |
| | weights and measures body-compatible (Specific standard to be determined). | 4 | 11 |
| 19 | The End Use Measurement Device shall allow for remote configuration of energy | 1, 2, 3 | 5 |
| | measurement interval length. | 4 | 11 |
| 20 | The End Use Measurement Device shall be capable of reporting all PEV | 1, 2, 3 | 6 |
| | charging session information and energy usage for PEV charging to the Energy | 4 | 12 |
| | Services Communication Interface. | | |
| 21 | The End Use Measurement Device shall be capable of communicating with the | 1, 2, 3 | 6 |
| | Utility via the Energy Services Communication Interface. | 4 | 12 |
| 22 | PEV, End Use Measurement Device, and Energy Services Communication | 1, 2, 3 | 2 |
| | Interface have established a secure communications link. | 4 | 5 |
| | | 5 | 3 |
| 23 | The Energy Services Communication Interface shall be capable of reporting all | 1, 2, 3 | 7 |
| | PEV charging sessions information and energy usage for PEV charging to the | 4 | 13 |
| | Utility. | | |
| 24 | The Utility shall accurately bill the correct customer account for the total kWhrs | 1 | 8 |
| | supplied during a predetermined billing period to a PEV, according to the | | |
| | selected rate tariff, when the PEV customer and the local premise customer are | | |
| | the same. | | |
| 25 | The Utility shall accurately bill the correct local premise customer account for the | 2 | 8 |
| | total kWhrs supplied during a predetermined billing period to a PEV, according to | | |
| | the selected rate tariff, when the PEV customer and the charging premise | | |
| | customer are NOT the same and the charging premise customer has been | | |
| | designated for PEV usage charges. | | |
| 26 | The Utility shall accurately credit the correct local premise customer account for | 3 | 8 |
| | the total kWhrs supplied during a predetermined billing period to a PEV, | | |
| | according to the selected rate tariff, when the PEV customer and the local | | |
| | premise customer are NOT the same and the PEV customer has been | | |
| | designated for PEV usage charges. Utility will handle billing PEV usage to utility | | |
| | account associated to PEV ID. | | |
| 27 | The Utility shall accurately credit the correct local premise customer account for | 4 | 14 |
| | the total kWhrs supplied during a predetermined billing period to a PEV, | | |
| | according to the selected rate tariff, when the PEV customer and the local | | |
| | premise customer are NOT the same and the PEV customer has been | | |
| | designated for PEV usage charges. | | |
| 28 | In the foreign/roaming utility charging case, Clearinghouse will handle billing | 4 | 16 |
| | transaction to home utility account associated to PEV ID and settling charges | | |
| | across utilities. | | |
| 29 | The Clearinghouse shall store the relationship between PEV ID, Home Utility ID, | 4 | 7 |
| | and Home Utility Account ID. | 5 | 6 |
| 30 | If ESCI communications cannot be established between PEV and Utility within a | 1, 2, 3 | 2 |
| | configurable period of time after ‘on plug’ state, charging will proceed (according | 4, 5 | 3 |
| | to customer preferences) with all charges accruing to premise customer account | | |
| | according to that customer's regular utility rate. | | |
| 31 | ESCI shall be able to provide the Premise ID to the Utility (along with PEV ID | 4 | 5 |
| | provided by PEV) for validation/verification. | 5 | 4 |
| 32 | Utility shall have a means to determine whether PEV operator/customer or | 2, 3 | 1 |
| | premise customer accrues energy charges when Premise Customer and PEV | | |
| | operator/customer are not the same. (Must be considered in enrollment | | |
| | scenario). | | |

### Non-Functional Requirements

| | | Associated | Associated |
|---|---|---|---|
| Non-func. | | Scenario # | Step # |
| Req ID | Non-Functional Requirements | (if applicable) | (if applicable) |
| NF. 1 | Time will be maintained by each device in the system to UTC with 1 | 1, 2, 3 | 5 |
| | second resolution | 4 | 11 |
| NF. 2 | EUMD shall record interval data configurable for interval lengths between | 1, 2, 3 | 5 |
| | 1 minute and 60 minutes inclusive. | 4 | 11 |
| NF. 3 | PEV attempts to initiate communication session before initiating charging. | 1, 2, 3 | 2 |
| | | 4, 5 | 3 |
| NF. 4 | PEV waits a minimum time (e.g., 1 minute) to allow for | 1, 2, 3 | 4 |
| | verification/validation before charging activation | 4 | 10 |
| | | 5 | 7 |
| NF. 5 | PEV begins charging with randomization at configured start time in | 1, 2, 3 | 4 |
| | charging preferences. This will prevent all PEVs from adding load to | 4 | 10 |
| | system at exactly the start of off-peak charging. | 5 | 7 |

| | Step #, | Information | Information | |
|---|---|---|---|---|
| Scenario # | Step Name | Producer | Receiver | Name of information exchanged |
| 1, 2, 3 | 2 | PEV | ESCI | PEV ID, Premise ID, Authorization Success Indicator |
| 5 | 4 | | | |
| 4 | 5 | ESCI | Utility | PEV ID, Premise ID |
| 4 | 6 | Roaming Utility | Clearinghouse | PEV ID |
| 5 | 5 | | | Premise ID |
| | | | | Foreign/Roaming Utility ID |
| 4 | 8 | Clearinghouse | Roaming Utility | Verification of PEV ID |
| | | | | Verification of Utility ID |
| | | | | Home Utility ID |
| | | | | Home Utility Account ID |
| | | | | Meter Interval |
| 4 | 9 | Roaming Utility | ESCI, End Use | For each ‘On Plug’ state session and once-a-day |
| | | | Measurement | Verification of PEV ID/Premise ID |
| | | | Device | Meter Interval |
| 1, 2, 3 | 6 | End Use | ESCI | Charging session event message |
| 4 | 12 | Measurement | | PEV ID |
| | | Device | | Premise ID |
| | | | | Metered energy supplied by each metering interval |
| 1, 2, 3 | 7 | ESCI | Utility | Charging session event message |
| 4 | 13 | | | PEV ID |
| | | | | Premise ID |
| | | | | Metered energy supplied by each metering interval |
| 4 | 15 | Utility | Clearinghouse | Charging session event message |
| | | | | PEV ID |
| | | | | Premise ID |
| | | | | Customer ID |
| | | | | Utility ID |
| | | | | Metered energy supplied by each metering interval |

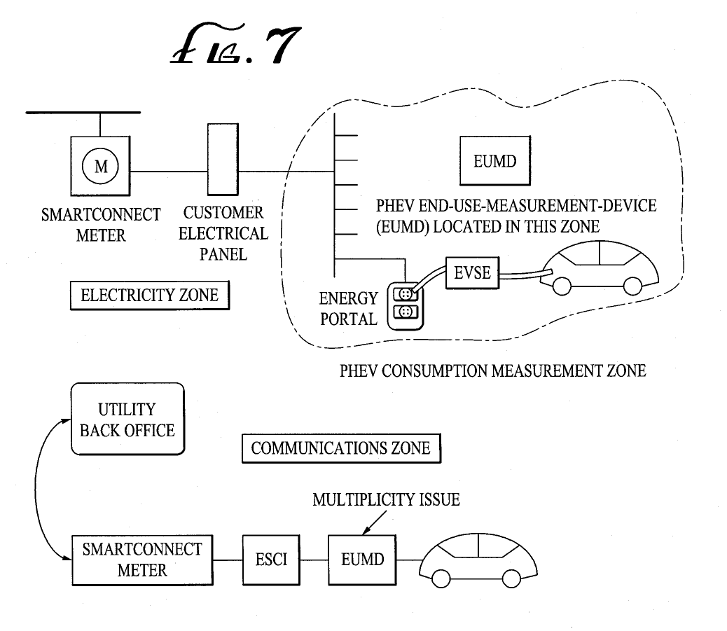

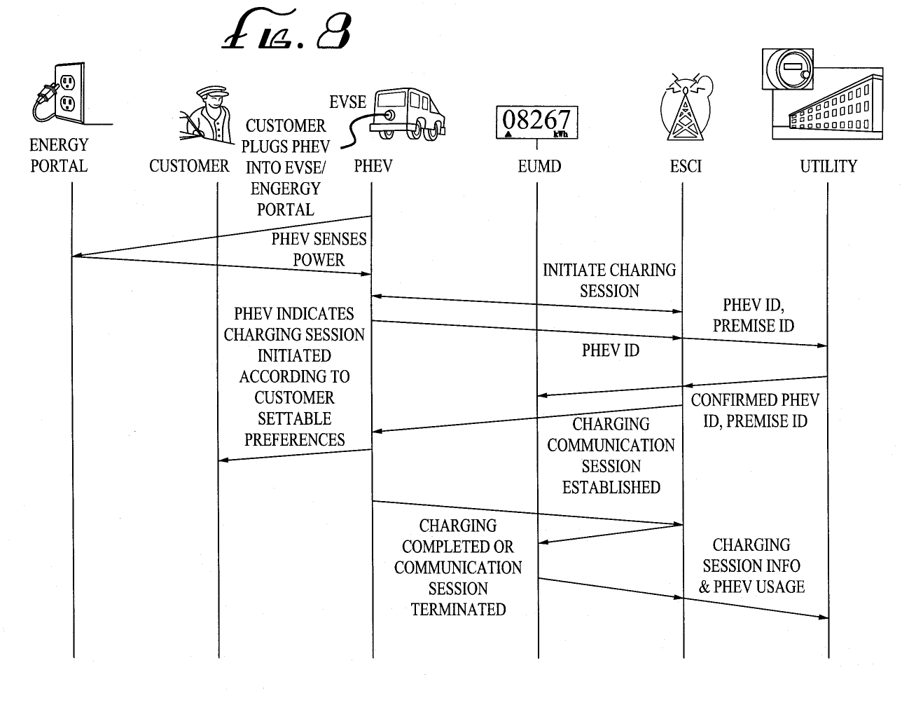

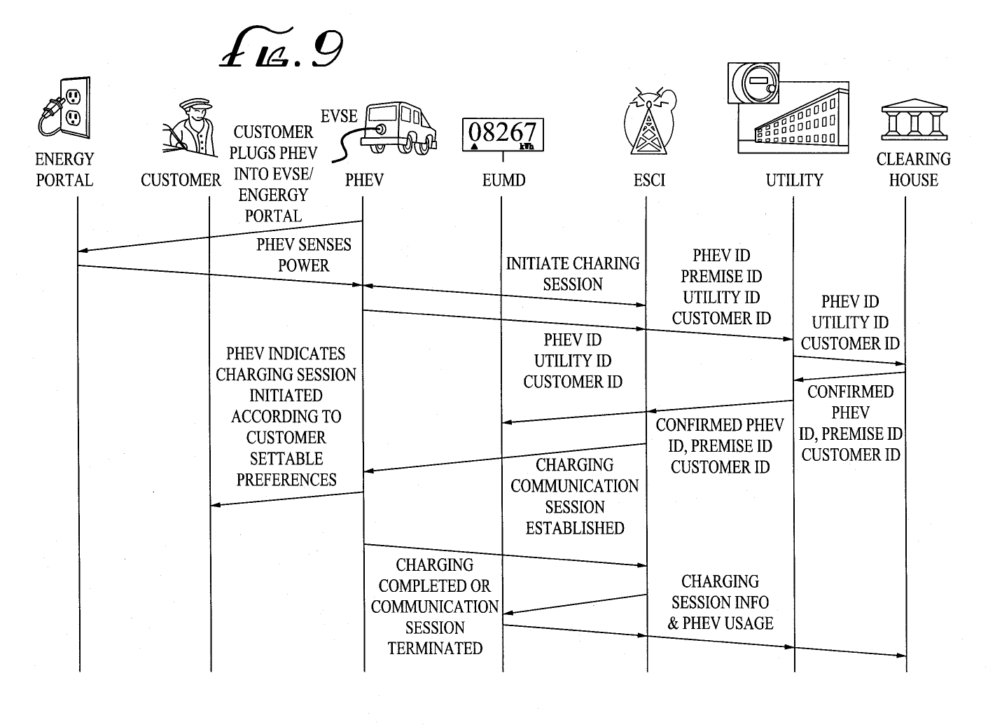

FIGS. 7, 8 and 9 graphically describe the step-by-step actor-system interactions for the above scenarios. FIG. 8 is the sequence diagram graphically depicting scenarios 1, 2 and 3. FIG. 9 is the sequence diagram graphically depicting scenario 4.

In this embodiment, the following terms have the listed meanings:

Glossary

| Term | Definition |
|---|---|
| Rate tariff | Energy cost schedule to customer. Can be time-of-day, flat |
| | rate, seasonal rate, critical peak price rate, etc. |
| PEV | Plug-in Electric Vehicle |
| EUMD | End Use Measurement Device, revenue measuring device |
| ESCI | Energy Services Communication Interface |
| Charging | Act of electrically charging a battery on-board a Plug-in |
| | Electric Vehicle or Electric Vehicle |

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A system for recharging the batteries in an electrically powered vehicle which is owned or operated by an authorized party, wherein the recharging of the batteries is carried out at a site away from premises owned or controlled by the authorizing party, the system comprising:
(a) first communication means for communicating between the site and an electrical utility for requesting the recharging of the batteries at the site;
(b) authorization confirmation means for confirming that the authorized party is in fact authorized to recharge the batteries at the site;
(c) second communication means between the electrical utility and the site for confirming authorization of the authorized party and for enabling the recharging of the batteries at the site; and
(d) accounting means for calculating the cost of recharging the batteries and properly assessing that cost to the authorized party.
